(19) United States
(12) Patent Application Publication
(10) Pub. No.: US 2024/0302639 A1
(43) Pub. Date: Sep. 12, 2024

(54) MICROSCOPE WITH AT LEAST ONE OPTICAL BEAM PATH

(71) Applicant: Carl Zeiss Microscopy GmbH, Jena (DE)

(72) Inventors: Tobias-Michael KAUFHOLD, Jena (DE); Johannes KNOBLICH, Jena (DE); Ralf WOLLESCHENSKY, Jena (DE); Jana LEPSCHI, Jena (DE)

(21) Appl. No.: 18/419,776

(22) Filed: Jan. 23, 2024

(30) Foreign Application Priority Data
Mar. 9, 2023 (DE) 10 2023 202 110.2

(51) Int. Cl. G02B 21/02

(52) U.S. Cl. CPC G02B 21/025

(57) ABSTRACT

A microscope with at least one optical beam path having a plurality of optical elements, of which at least two per beam path are adjustable along the beam path and relative to one another in order to effect a change in an optical magnification of an image generated by means of the optical beam path; an operating device for selecting the magnification; and a gearbox for generating and transmitting a positioning displacement of the adjustable optical elements along the optical beam path which is associated with a magnification selected on the operating device and effected by means of a drive.

A drive is assigned to each of the adjustable optical elements of an optical beam path or corresponding adjustable optical elements of the beam paths, so that the adjustable optical elements of an optical beam path can be displaced independently of one another.

The invention relates to a microscope according to the general term of independent claim 1.

The use of pancratic systems in microscopes is used to change the focal length of an optical system, in particular an optical beam path. As a result of the change in focal length, a change in the size of a generated image is achieved, wherein the image width remains constant. For this purpose, one or more lenses in an optical system with several optical lenses are shifted in the direction of the optical axes so that the image scale changes without the distance to the object changing. Such pancratic systems are also known as magnification changers, zoom systems or zoom for short.

In order to effect certain magnifications, the positions at which the moving lenses or lens groups must be located are specifically defined for each optical system so that a certain magnification of the system results in each case. The positions and the changes in position of the individual moving lenses (groups of lenses) required to change the magnification are also referred to as zoom curves or control curves. Depending on the embodiment of the optical design, these can have very different path lengths, changes in the positioning speed (increases) and also reversal points, i.e., a reversal of the direction of the positioning movement.

The control curves are realized in mechanical zoom systems as cam disks, gearbox, or rods to be scanned, by the action of which the adjustable optical elements involved are brought into their required positions. A major advantage of such mechanical systems is the direct optical effect, i.e., without a time delay, during a manual adjustment process. The immediate effect of a manual adjustment process provides the user of the microscope with a high degree of user-friendliness and intuitive usability of such a mechanical zoom system. An example of such a mechanically adjustable zoom system is known from DE 10 2006 058 943 A1.

However, mechanical systems often exhibit play, albeit very small, between the mechanical components despite precise manufacturing. In addition, frequent use can lead to signs of wear. When adjusting the zoom system, the mechanics must be set so that the individual tolerances of all components are compensated for in such a way that a “sharp” image of the object plane is produced in the image plane over the entire positioning range. The set magnification must match the label on the zoom knob within a certain tolerance range. Depending on the magnification and aperture of the respective setting, this results in a depth of field range that is perceived as an impression of sharpness. The permissible magnification tolerance is usually between 5 and 10% of the displayed magnification. For a measurement task, the user must always carry out an additional calibration for each zoom position.

The task of the invention is to propose a possibility for a manually operated zoom system that reduces the disadvantages known from the prior art while retaining the user-friendliness and direct response behavior of a mechanical zoom system.

The problem is solved by the object of independent claim 1. Advantageous further developments can be found in the dependent claims.

The task is solved using a microscope with at least one optical beam path. The microscope comprises a plurality of optical elements, of which at least two per optical beam path are adjustable along the optical beam path and relative to each other in order to effect a change in an optical magnification of an image generated by means of the optical beam path. The adjustable optical elements, possibly in combination with further optical elements, form the pancratic system or zoom system. This is operated by means of an operating device for manual selection of the respective magnification to be set. The microscope also has a gearbox for generating and transmitting a positioning displacement of the adjustable optical elements along the optical beam path which is associated with a magnification selected on the operating device and effected by means of a drive.

A characteristic feature of the invention is that a drive is assigned to each of the adjustable optical elements of a beam path or to corresponding adjustable optical elements of the beam paths, so that the optical elements of a beam path can be moved independently of one another. The adjustable optical elements are therefore not mechanically coupled to each other. The drives are designed as piezo motor drives.

The core of the invention is the realization that the advantageous immediacy of a mechanical zoom system can be imitated to a very high degree using piezo drives. At the same time, the use of a separate drive for each adjustable optical element means that even complicated relationships between the adjustment movement sequences of the at least two adjustable optical elements can be easily implemented. For example, the necessary reversing movements of individual adjustable optical elements can be generated independently of the movements of the other optical elements, which is complicated by means of a purely mechanical design and requires a large installation space. The use of piezo drives therefore also enables a space-saving design of an optical beam path.

Whereas a manually operated and mechanically designed zoom system is actuated by the user's muscle power, i.e., the user acts as the drive, the drives in a microscope according to the invention are formed by motors based on the piezoelectric effect. These drives receive their control commands as a result of actuation of the operating device, which is designed, for example, as a rotary switch, motor feedback rotary encoder, rocker switch, slider, foot pedal, joystick, or similar. In further embodiments, the operating device can also be provided in the form of an interactive graphic on a display (display, touchpad).

A force generated by the drives is converted into a movement of the respective adjustable optical element along the optical beam path by means of a gearbox (see below).

In order to record both the current positions of the adjustable optical elements and the positioning displacement traveled, a displacement measuring system is advantageously assigned to each adjustable optical element. These displacement measuring systems can, for example, have a magnetic rail provided with a scale (graduation) and a magnetic sensor (for example: Linear Encoder; NANOS-Instruments GmbH, Hamburg), whose relative offset to each other during a positioning movement indicates the displacement traveled and a position reached.

In one embodiment of the microscope according to the invention, the magnifications are advantageously dynamically adjustable within a technically predetermined magnification range. A user is therefore not bound to predetermined discrete magnification levels. During a dynamic change in magnification, the focus position remains advantageously within a range of half the depth of field, so that the user is given a sharp image impression at all times.

A further advantage of the invention is also provided if the dynamic positioning accuracy of a positioning movement is less than 10 μm per drive over the entire magnification range. Such an embodiment of the microscope according to the invention combines a direct reaction of the zoom system to the actuation of the operating device and a high precision of the zoom system.

In order to further support the direct reaction and also to reduce or completely avoid noise from the drives that is audible to the human ear, piezo motor drives can be designed as so-called ultrasonic motors, which are operated with stator frequencies in the ultrasonic range (ultrasonic motors). The ultrasonic range covers frequencies from 20 kHz to 1 GHz. Ultrasonic motors can, for example, be operated with stator frequencies selected from a range of 100 to 200 KHz.

In scientific devices such as microscopes, especially high-resolution microscopes, it is much more important than when using piezo drives in cameras that the positioning movements of the adjustable optical elements and the associated movements and force effects of the drives and gearbox do not have a negative effect on the precise adjustment of the optical elements in the beam path. Therefore, in one embodiment of the microscope according to the invention, the adjustable optical elements are guided axially by means of a guide and prevented from undesired lateral movement. In the microscope, there is at least one guide per optical beam path arranged parallel along a section of the beam path, which can be designed as a guide rod or a guide rail, for example. The optical elements, which can be adjusted and moved along the beam path, are attached to this. The invention is described below by way of example using a guide rod.

In order to be able to adjust the adjustable optical elements of the zoom system by means of the respective drive and by means of a gearbox, two basic embodiments are provided. In one possible embodiment of the microscope according to the invention, the adjustable optical elements are each arranged together with an actuator on a carriage that can be moved along the guide rod. The actuator changes its shape as a result of controlled applied electrical voltages, thereby generating a force. The actuator, which is mounted in a movable position, interacts with a friction rail arranged in a fixed position on a frame (stand) of the microscope in order to generate a force effect and positioning movement between the carriage and frame.

In a second embodiment, the adjustable optical elements are each arranged together with a friction rail that can be moved by the action of the actuator mounted in a fixed position on the frame on a carriage that can be moved along the guide rod.

The friction rail and components of the drive that interact with it, for example a transmission element between the actuator and friction rail, are regarded as gearbox in the context of this description.

The actuating forces of the actuators on the associated friction rails required for the piezoelectric drives to function are between 10 and 20 Newtons, for example. In the dimensioning and tolerancing of the guide rods, for example, the rod diameter is selected in combination with a sufficiently high mechanical rigidity and a low guide play in order to absorb as far as possible the actuating forces of the drives acting approximately vertically on the guide rods. This reduces decentering of the adjustable optical elements and undesirable changes in the image positions and center deviations. These lateral forces acting on the guide rods can be compensated for by additional spring elements.

Both of the aforementioned embodiments can also be implemented in a microscope. Thus, one of the adjustable optical elements can be driven with the first embodiment and further adjustable optical element with the second embodiment.

The components of an existing displacement measuring system can also be mounted in a fixed or movable position. For example, a magnetic rail can be stationary and an encoder can be movable, or vice versa.

In a further embodiment of the microscope according to the invention, at least one, some or all of the drives present can each be provided with a coupling element. The positioning force of the drive is transmitted to the adjustable optical element in question by means of the actuator. In an advantageous embodiment, the coupling element transmits a force to the adjustable optical element, particularly in the direction of the guide rod. In contrast to the aforementioned exemplary embodiments, in this embodiment no or only very little lateral pressure is exerted on the guide rod, so that undesired lateral movement of the adjustable optical elements is avoided.

In these embodiments of the invention, undesirable effects of forces acting laterally on the guide rods can also be further reduced, for example by providing the coupling element with additional spring elements.

In order to actuate the individual drives to effect the desired magnification, a microscope according to the invention advantageously has a control device for generating control commands and for actuating the drives by means of the control commands. The control commands are generated on the basis of a control function. The control function encodes relative positions of the adjustable optical elements depending on their current position and the selected magnification. The control commands generated specify the direction (positioning direction), the positioning speeds and the positions in which the respective adjustable optical elements are to be moved from a current position in order to effect a magnification specified by the operating device. The control functions can, for example, be provided as tables (look-up tables) or as mathematical rules for an application. The corresponding positioning movements are effected by the execution of the control commands by the drives. The positioning movements of the adjustable optical elements are advantageously coordinated with each other in such a way that a sharp image, i.e., a sharp image of an object or a sample, for example, is made available to the user during the entire positioning process. The control function corresponds in its effect to the guide curve of a mechanical zoom system.

A control function can be stored in a command memory and retrieved from it. In order to be able to operate a microscope with different object lenses, for example, a plurality of selectable control functions can be stored or saved in the command memory. Such a command memory can be an area of a memory unit, for example a memory chip, a CPU, a ROM, a virtual memory (cloud), etc. Depending on the object lens currently in use, for example, a selected control function can be retrieved from the command memory by the control device and executed.

In order to address the different optical properties of, for example, different object lens and/or different magnification ranges assigned to them, the retrievable control functions advantageously comprise different relationships between the positioning movements of the adjustable optical elements and a respective realized adjustment displacement and/or an adjustment speed of the operating device. For example, a partial range of the total possible magnification changes of the zoom system can be assigned to a specific object lens. However, in order to be able to continue to provide the user with an appropriate range of rotation angles when setting a magnification, the ratio of, for example, a change in angle (adjustment displacement) of a rotary knob serving as an operating device and an effective positioning displacement of the adjustable optical elements can be adapted. In this way, it is possible to ensure that the adjustment displacement is not different for different configurations of the microscope. In particular, it can be avoided that the adjustment displacement becomes very small and cannot be precisely adjusted manually. On the other hand, it is possible to prevent the user from having to reach around the operating device several times if the adjustment displacement is too large. Such an embodiment of the invention increases the ease of use of the microscope.

In a further embodiment of the microscope according to the invention, at least one of the retrievable control functions can realize different coded fixed magnifications. The user selects a magnification from a selection of fixed magnifications at the operating device and effects the selected magnification by means of the control function, its conversion into control commands and their execution. In this way, a common operating mode (also known as click-stop mode) familiar to users of purely mechanical zoom systems can be provided by the invention.

Click stops are predefined click positions that can be set reproducibly and correspond to the specified magnifications. With suitable calibration of an operating device, for example an encoder on a rotary knob, click stops can be realized with the invention, which, in contrast to the mechanical zoom system, allow a higher positioning accuracy. In mechanical zoom systems with click stops, for example, the specified image scales can only be set with an accuracy of 5% due to the mechanical tolerances of the click-stop mechanism. In contrast, the deviations for click stops according to the invention are <<1%.

In a further embodiment of the invention, the control functions can be modified by a user. For example, fixed magnifications can be added, changed, or deleted. It may also be possible to adjust control functions, for example to correct certain areas if the user does not get a sharp image impression over the entire magnification range (zoom range).

The advantages of the invention lie in the low-noise operation of the drives, while retaining the directness and intuitive operability of a mechanical zoom system. The positioning speed is around 4 times higher than that of motor-spindle drives, while the positions can be set with an accuracy of less than 10 μm even in dynamic operation. A focus position can be achieved within half the depth of field (<<T/2). The deviations of the image scales are only 1% to 1%). The control functions used allow individual actuation of the drives without them being mechanically coupled to each other.

In addition, the control functions can be easily adapted to different applications and/or system-specific features, for example specific correction values required for an individual optical beam path. Piezo motor drives provide holding forces that are so high that safe operation is possible without step losses or incorrect positioning, regardless of the positional orientation of the zoom system in space. Additional safety is provided by the embodiment of the piezo drives as controlled systems, in which the integrated displacement measuring systems ensure precise positioning of the carriages (lens carriers). With the technical solution described here, the following properties could be demonstrated in the test: the entire magnification range can be traversed in less than one second; the static and dynamic positioning accuracy is <10 μm; the required installation space is comparable or smaller than with mechanical zoom systems; and the virtual and individualized control functions can be created, for example with a polynomial and an error <3 μm, wherein, for example, a connection to platforms such as Matlab is possible.

The invention makes it possible to extend the tolerances of individual parts and assemblies, for example, because there is no need to produce a high-precision mechanical guide curve. In addition, modern displacement measuring systems can handle assembly and production tolerances very well. Adjustment can be carried out automatically using a suitable device, wherein the magnification values can be measured precisely and also stored. The individual motor positions and magnification values are saved in the device (e.g., as a look-up table) and represent the individual zoom curve for this device model. The control functions can therefore not only be type-specific, but can also be individually adapted to individual devices.

For example, the so-called force feedback technology known in the state of the art can be used advantageously, in which, for example, motor feedback rotary encoders are actuated with a corresponding firmware/software in order to generate the desired operating feedback. In the process, a user is given corresponding force feedback at the operating device in response to their inputs. In this way, the feel of a mechanical system is recreated. The actual transmission of the input commands to the control device can be purely electrical.

If such a motor feedback rotary encoder is used to operate the zoom system, a specially programmed motor feedback can be used to create a very realistic and immediately responsive operation similar to a mechanical zoom system. This has the immediate advantage that the user can adjust the zoom system quickly, without delay and, when changing the direction of an adjustment, with virtually no hysteresis and precision. In conjunction with the high positioning speed of the piezo drives, fast zoom adjustment is possible, as with mechanical zoom systems. The programmability of the motor feedback rotary encoders offers further advantages for the user compared to mechanical zoom systems. This allows different actuating torques and angles of rotation to be realized on the rotary encoder, which can be selected depending on the application requirements. Furthermore, different selectable speed profiles for zoom adjustment can be implemented depending on the application requirements. For example, a quick adjustment between two programmable fixed magnifications can be made to provide a quick changeover from overview magnification to detail magnification, as used for routine examinations in quality assurance, for example. It is also possible to zoom through sensitively in jog shuttle mode.

The invention is explained in more detail below with reference to exemplary embodiments and illustrations. It shows:

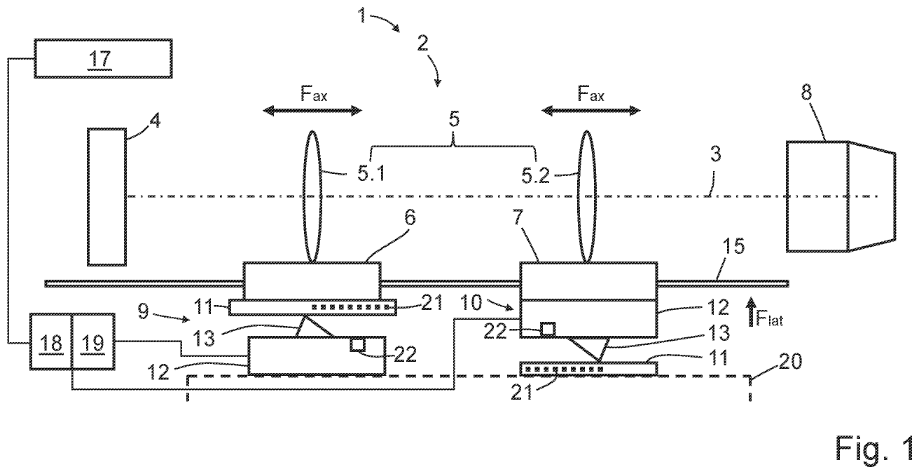

FIG. 1 a schematic representation of a first exemplary embodiment of an optical beam path of a microscope according to the invention;

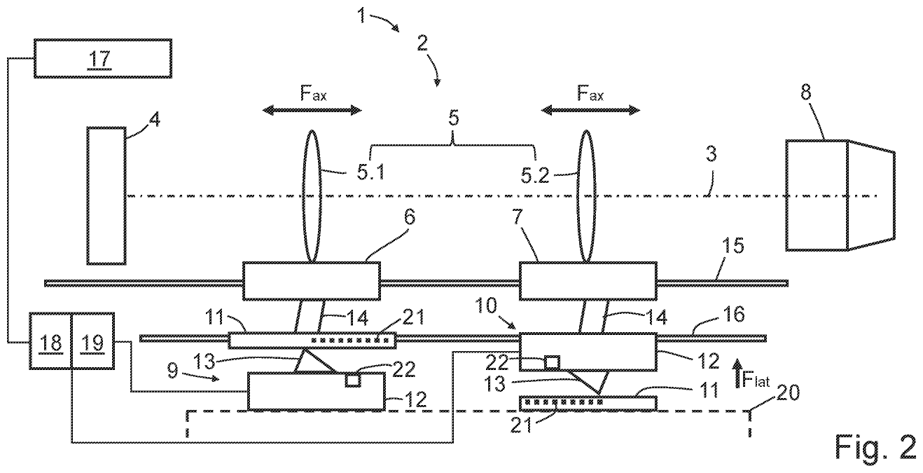

FIG. 2 a schematic representation of a second exemplary embodiment of an optical beam path of a microscope according to the invention; and

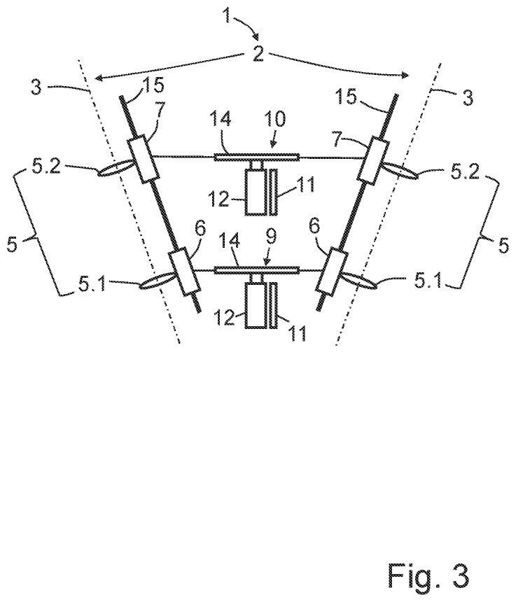

FIG. 3 a schematic representation of an exemplary embodiment of a microscope according to the invention with two optical beam paths.

A microscope 1 according to the invention has an optical beam path 2, in which a detector 4, a zoom system 5 and a likewise optional object lens 8 are optionally present along an optical axis 3 (FIG. 1). Further optical elements may also be present. The zoom system 5 comprises at least a first optical lens 5.1 and a further optical lens 5.2 as adjustable optical elements. Instead of individual optical lenses, several optical lenses can also be present, which are referred to here for simplicity as first or further optical lenses 5.1, 5.2, if they can each be adjusted together along the optical axis 3. The adjustable optical elements 5.1, 5.2 are attached to carriages 6 and 7 respectively. The carriages 6, 7 are each connected to a piezoelectric drive 9 or 10, which has a friction rail 11, an actuator 12, and a transmission element 13. The actuator 12 is used to generate a movement using the piezoelectric principle and can, for example, be designed as an ultrasonic motor. The generated movement is transmitted to the friction rail 11 by means of the transmission element 13. As either the actuator 12 or the friction rail 11 are stationary, a relative movement is generated between the actuator 12 and the friction rail 11. The transmission element 13 is designed in such a way that a force Fₗₐₜ acting laterally with respect to the optical axis 3 is converted into a force Fₐₓ acting axially along the optical axis 3. In FIG. 1, a friction rail 11 connected to the carriage 6 is shown using the first adjustable optical element 5.1 as an example. The associated actuator 12 is mounted in a fixed position on a frame 20 (shown with a broken solid line) of the microscope 1. In contrast, the actuator 12 is attached to the carriage 7 of the further adjustable optical element 5.2 and the associated friction rail 11 is arranged on the frame 20. Whether the actuator 12 or the friction rail 11 of a drive 9, 10 is mounted in a fixed position can be implemented as desired in further embodiments of the invention and, for example, depending on the available installation space.

In order to maintain a positioning of the adjustable optical elements 5.1 and 5.2 transverse to the optical axis 3 during a positioning movement, the carriages 6 and 7 are advantageously attached to or on a guide 15 in the form of a guide rod which runs parallel to the optical axis 3. The guide rod 15 holds the adjustable optical elements 5.1, 5.2 in a correct lateral position on the optical axis 3 and absorbs laterally acting forces Fₗₐₜ of the drives 9, 10.

The actuators 12 are each connected to a control device 18, which is configured to generate control commands, in a manner suitable for transmitting control commands. There is also a command memory 19 in which at least one control function is stored. This determines the positioning movements of the adjustable optical elements relative to each other in order to achieve the desired optical effect. The optical effect is selected by means of an operating device 17. For example, a desired magnification of an image captured by the object lens 8 and directed to the detector 4 by the action of the zoom system 5 is selected by a user and set on the operating device 17. According to the known current positions of the lenses 5.1 and 5.2 and the desired magnification, the required control commands are generated by the control device 18 using the control function, transmitted to the actuators 12 and executed by them. If the desired magnification is continuously changed by the user, the positions of lenses 5.1 and 5.2 are continuously (dynamically) adjusted according to the control function used.

Various control functions can be stored in the command memory 19. These can be optionally selected by the user. Alternatively, based on a set of optical elements currently used with the microscope 1, for example a respective object lens 8, a suitable control function, for example assigned to a type of object lens 8, is automatically selected and applied.

In order to be able to determine the current positions of the adjustable optical elements as well as the current positioning displacement traveled, each of the drives 9, 10 is equipped with a displacement measuring system. In FIG. 1, for example, a magnetic rail 21 (shown as a dotted line) finely subdivided in the sense of a scale is attached to or next to the friction rail 11. A sensor 22 is provided on or next to the actuator 12, by means of which measured values are generated and evaluated during a positioning movement or at a position based on the magnetism of the magnetic rail 21. The measured values are transmitted to the control device 18 for further evaluation (not shown for reasons of clarity). The information on the respective current positions, positioning directions and positioning speeds enables the respective lenses 5.1 and 5.2 to be positioned very quickly and precisely using the control function, while at the same time providing the user with a sharp image impression at all times.

In a second exemplary embodiment of the microscope 1 according to the invention, a further guide 16 is provided in addition to the guide rod 15. The friction rail 11 or the actuator 12 are optionally attached to this and can be moved parallel to the optical axis 3 and the guide rod 15 (FIG. 2). The stationary antagonists of the parts of the drive 9, 10 held in their position lateral to the optical axis 3 by means of the guide 16 are attached to the frame 20. In the exemplary embodiment shown, these are the stationary friction rail 11 and the stationary actuator 12. In order to communicate a positioning movement of the respective actuator 12 to the carriage 6 or 7, a coupling element 14 is provided between the parts of the drive 9 or 10 held on the guide 16, which connects them to the respective carriages 6, 7 and fulfills this task.

The advantage of this embodiment is that the lateral forces Fₗₐₜ occurring between the friction rail 11 and actuator 12 are largely or completely absorbed by the guide 16. Essentially, only an axially directed force Fₐₓ acts on the carriages 6, 7.

In microscopes 1 with several optical beam paths 2, a device as described in FIGS. 1 and 2 may be present in one or more of them.

A further implementation of the invention in a microscope 1 is shown in simplified form in FIG. 3. The microscope 1 is an example of a Greenough design and has two optical beam paths 2. The inclination and the relative distance of the optical axes 3 to each other are shown in a pronounced manner for illustrative purposes. Along each of the optical axes 3 there is a guide rod 15, which carries corresponding lenses 5.1 and 5.2 on carriages 6 and 7 respectively. One drive 9, 10 is assigned to each pair of corresponding lenses 5.1 and 5.2. In the exemplary embodiment, the friction rails 11 are arranged in a fixed position. The coupling element 14 is designed as a horizontal central guide element, which engages the respective carriage 6 or 7 with telescopically extendable arms in order to transmit the axially acting positioning force Fₐₓ to them.

### REFERENCE SYMBOL

1 Microscope
2 Optical beam path
3 Optical axis
4 Detector
5 Zoom system
5.1 First lens
5.2 Further lens
6 First carriage
7 Further carriage
8 Object lens
9 First drive
10 Further drive
11 Friction rail
12 Actuator
13 Transmission element
14 Coupling element
15 Guide rod
16 Guide
17 Operating device
18 Control device
19 Command memory
20 Frame
21 Magnetic rail
22 Sensor
Fₗₐₜ Lateral force
Fₐₓ Axial force

1. A microscope with at least one optical beam path, comprising
a plurality of optical elements, of which at least two per beam path are adjustable along the beam path and relative to one another in order to effect a change in an optical magnification of an image generated by means of the optical beam path;
an operating device for selecting the magnification;
a gearbox for generating and transmitting a respective travel of the adjustable optical elements along the optical beam path, which positioning displacement is associated with a magnification selected on the operating device and effected by means of a drive;
wherein
a drive is assigned to each of the adjustable optical elements of an optical beam path or to respectively corresponding adjustable optical elements of the beam paths, so that the adjustable optical elements of an optical beam path can be displaced independently of one another; and
the drives are piezo motor drives.

2. The microscope according to claim 1, wherein magnifications are dynamically adjustable within a technically predetermined magnification range.

3. The microscope according to claim 1, wherein the piezo motor drives are each operated with stator frequencies in the ultrasonic range.

4. The microscope according to claim 1, wherein the dynamic positioning accuracy of one positioning movement per drive is less than 10 μm.

5. The microscope according to claim 1, wherein
at least one guide arranged parallel along a section of the optical beam path is provided for each optical beam path; and
the optical elements which can be adjusted and moved along the optical beam path are attached to the guide.

6. The microscope according to claim 5, wherein the adjustable optical elements are each arranged together with the drive on a carriage which can be moved along the guide.

7. The microscope according to claim 5, wherein the adjustable optical elements are each arranged together with a friction rail movable by the action of the drive on a carriage which can be moved along the guide.

8. The microscope according to claim 5, wherein the drives are each provided with a coupling element, by means of which a positioning force of the drive is transmitted or can be transmitted to the respective adjustable optical element; wherein a force action on the adjustable optical element on the part of the coupling element takes place in the direction of the course of the optical beam path.

9. The microscope according to claim 1, wherein
a control device for generating control commands and for actuating the drives by means of the control commands,
wherein the control commands are generated on the basis of a control function, and
wherein the control function encodes relative positions of the adjustable optical elements as a function of their current position and the selected magnification.

10. The microscope according to claim 9, wherein a command memory is provided, in which a plurality of selectable control functions is stored or can be stored, wherein a respectively selected control function can be retrieved and executed by means of the control device.

11. The microscope according to claim 9, wherein the retrievable control functions comprise different relationships between the positioning movements of the adjustable optical elements and a respective realized adjustment displacement and/or an adjustment speed of the operating device.

12. The microscope according to claim 9, wherein the retrievable control functions realize different coded fixed magnifications.

13. The microscope according to claim 9, wherein the control functions are modifiable by a user.

14. The microscope according to claim 9, wherein each of the drives is provided with a displacement measuring system, by means of which a current position of the elements of the drive is measured and made available to the control device for evaluation.

15. The microscope according to claim 1, wherein a transmission of input commands of a user at the operating device to the control device takes place using the force feedback technology method.
